(19) United States
(12) Patent Application Publication
(10) Pub. No.: US 2026/0109097 A1
(43) Pub. Date: Apr. 23, 2026

(54) RECYCLING A MULTILAYER SYSTEM

(71) Applicant: Bostik SA, COLOMBES (FR)

(72) Inventors: Christophe ROBERT, VENETTE (FR); Romain PUCHOIS, VENETTE (FR)

(21) Appl. No.: 19/118,096

(22) PCT Filed: Oct. 5, 2023
(86) PCT No.: PCT/FR2023/051543

§ 371 Date: Apr. 3, 2025

(30) Foreign Application Priority Data
Oct. 12, 2022 (FR) FR2210474

(51) Int. Cl. B29C 48/00; B29C 48/18; B29C 48/40; B29K 23/00

(52) U.S. Cl. CPC B29C 48/0018; B29C 48/18; B29C 48/40; B29C 2948/92133; B29C 2948/92142; B29C 2948/92152; B29C 2948/9218; B29C 2948/92704; B29K 2023/12; B29K 2995/0053

(57) ABSTRACT

The present invention relates to a multilayer system F1 comprising: a layer C1 comprising at least one polypropylene, an adhesive layer Ad made up of a hot-melt self-adhesive composition CA, and a layer C2 comprising at least one polypropylene, said multilayer system F1 comprising at least 80% by weight of polypropylene or a mixture of polypropylenes relative to the total weight of said system. The invention also relates to the use of said system F1 for producing a recycled item.

### FIELD OF THE INVENTION

The present invention relates to a process for recycling a multilayer system.

The present invention also relates to the use of a hot-melt pressure-sensitive adhesive composition or of a multilayer system for preparing a recycled article.

### TECHNOLOGICAL BACKGROUND

Multilayer articles (or laminated articles) are used in many fields for the packaging of a wide variety of products, in particular in the food processing, cosmetics and detergents sectors. Depending on the requirements, these articles may be flexible or rigid. They are in particular flexible packagings. These articles generally consist of different materials (composite multilayer articles). The materials may be chosen from paper, metal or thermoplastic polymers. The thermoplastic polymers may be chosen from polyethylene (PE), polypropylene (PP), copolymers of ethylene and vinyl acetate (EVA), polyamide (PA), polyethylene terephthalate (PET), polyvinyl chloride (PVC), polyvinylidene fluoride (PVDF), polymers derived from lactic acid (PLA), polyhydroxyalkanoate (PHA), or mixtures thereof.

An individual layer of material may itself consist of several materials. It may be, for example, a layer of thermoplastic polymers obtained by coextrusion of two polymers (there is then no adhesive between the coextruded layers), the individual layers of thermoplastic polymer may also be coated with a substance (for example based on aluminum oxide or silicon oxide), a layer of protein or a metallized layer (metallization with aluminum particles) to add an additional barrier effect.

The characteristics and properties of multilayer articles will depend in particular on the materials used to produce the layers. Thus, it is common practice to combine layers comprising different materials in order to obtain multilayer articles, very generally composite multilayer articles, combining the characteristics and the properties of the different individual layers and thus having particular characteristics and properties, for example in terms of visual appearance, of gas- and moisture-barrier properties, of harmlessness or of absence of toxicity to users, of inertness with respect to the packaged products, of chemical resistance to the packaged products and/or of physical, mechanical, thermal and chemical resistance to the manufacturing and packaging processes.

The layers can be assembled by lamination using lamination processes or by coextrusion. These lamination processes may be implemented via the use of adhesive compositions or suitable devices.

Multilayer articles include resealable trays, which are used in the food-processing industry and by large retailers to package foodstuffs, in particular fresh products. Such packagings are described by the patent U.S. Pat. No. 4,673,601 and the patent application EP 1 053 952. These trays are based on hot-melt pressure-sensitive adhesive compositions typically comprising tackifying resins and styrenic block copolymers. The hot-melt adhesive compositions are also commonly referred to as HMPSA compositions, corresponding to the initials of the term “Hot-Melt Pressure-Sensitive Adhesive”. These are substances which are solid at ambient temperature and which contain neither water nor solvent. Applied in the molten state, they solidify as they cool, thus forming an adhesive layer which provides the bonding between the two thin layers of thermoplastic polymeric material to be assembled, while providing the corresponding packaging with the advantageous opening and resealing properties.

There exists today a great diversity of multilayer articles comprising characteristics and properties suitable for multiple uses. However, these articles generally have the disadvantage of being single-use articles and of generating waste. In order to meet the challenge of climate change, to reduce environmental pollution, to save on natural resources and to adapt to more stringent regulations, it is imperative to develop recycling and upgrading channels for this waste.

Despite the development of various recycling and upgrading channels, many multilayer articles are difficult to recycle, whether for reasons of yield, of technical feasibility, of performance, of cost, etc. Thus, for example, the recycled materials obtained do not necessarily have the characteristics and the properties required for the production of new articles, such as molded articles: deterioration of the mechanical and/or physical properties, incompatibility, haze, etc.

There thus exists a need for new solutions which make it possible to overcome these disadvantages, at least in part.

There thus exists a real need to provide multilayer articles which can be recycled, in particular mechanically, to result in recycled articles having satisfactory mechanical and physicochemical properties and characteristics.

### DESCRIPTION OF THE INVENTION

### Multilayer System F1

The present invention relates to a multilayer system F1 comprising:
a layer C1 comprising at least one polypropylene,
an adhesive layer Ad consisting of a hot-melt pressure-sensitive adhesive composition CA comprising:
   i) from 40% to 80% by weight of at least one copolymer A comprising more than 80% by weight of units derived from but-1-ene;
   ii) optionally at least one copolymer T comprising more than 50% by weight of units derived from propylene;
   iii) at least one nonhydrogenated tackifying resin obtained by polymerization, or copolymerization with an aromatic hydrocarbon, of mixtures of unsaturated aliphatic hydrocarbons having from 4 to 6 carbon atoms obtained from petroleum cuts;
a layer C2 comprising at least one polypropylene, said multilayer system F1 comprising at least 80% by weight of polypropylene or of a mixture of polypropylenes, relative to the total weight of said system.

The multilayer system F1 necessarily comprises at least these three layers C1, C2 and Ad.

In the context of the present invention, the terms “article”, “structure” and “system” are used equivalently.

The multilayer system F1 may be a laminate, a complex or a film.

Advantageously, the multilayer system F1 is mechanically recyclable.

The term “mechanically recyclable” is used to indicate that the multilayer system F1 can be converted into a new article via a mechanical recycling process.

Mechanical recycling has been known for many years. In environmental terms, mechanical recycling (in comparison with chemical recycling) is the most energy-efficient and generates little waste. Chemical recycling is in particular defined by the standard ISO-15270 as being the conversion into monomers or the production of new starting materials by modification of the chemical structure of plastic waste by cracking, gasification or depolymerization, excluding energy recovery and incineration.

In the context of the invention, the term “mechanical recycling” is understood to mean the definition given in the standard ISO-15270, namely the processing of plastic waste into secondary starting materials or products, without significantly modifying the chemical structure of the material, for example without modifying the chemical functions and repeating units. Mechanical recycling comprises at least one mechanical grinding step.

In the context of the invention, the terms “recycled” and “recyclate” refer to a material derived at least in part either from post-consumer waste or from industrial waste. Post-consumer waste relates to objects which have been used by the consumer at least once already (that is to say that they have served their original purpose), while industrial waste relates to manufacturing residues that do not reach the consumer. Manufacturing residues may, for example, be scraps from reels of multilayer complexes when they are cut after production to prepare packagings.

In the context of the invention, the term “virgin” refers to newly produced materials and/or articles prior to their first use and which have not been recycled.

### Layers C1 and C2

The layer C1 may comprise a polypropylene or a mixture of polypropylenes.

The layer C2 may comprise a polypropylene or a mixture of polypropylenes.

The layers C1 and C2 may comprise one or more polypropylenes having different physicochemical characteristics.

An example of polypropylene having the same chemical nature (same chemical composition) but different physicochemical characteristics is: the layer C1 comprises a polypropylene having an MFI<10 g/10 min, the layer C2 comprises a polypropylene having an MFI>10 g/10 min. Thus, the chemical nature is identical, polypropylene, but the physicochemical characteristics, such as the MFI, are different.

The physicochemical characteristics of the layers C1 and C2 may be different, for example due to differences in the molecular weight of the polypropylene(s), the degree of branching of the polypropylene(s), the MFI, the density of the polypropylene(s), the thickness of the layer, etc.

The layers C1 and C2 may comprise one or more identical or different polypropylenes.

The term “polypropylene” covers homopolymers and copolymers prepared from propylene, said copolymers comprising at least more than 50 mol % of units derived from propylene monomer(s).

The polypropylenes may be prepared by different methods, such as polymerization in the presence of a Ziegler-Natta catalyst or a metallocene catalyst.

There also exist commercial polypropylenes, such as, for example, RC2472, available from HMC Polymers; RD226CF, available from Borealis; Eltex P, available from Ineos; PPR 3260, available from Total; RD204CF (random copolymer, MFI=8 g/10 min at 230° C./2.16 kg), available from Borealis.

The thickness of the layer C1 may range from 10 to 120 μm, preferably from 10 to 100 μm.

The thickness of the layer C2 may range from 10 to 120 μm, preferably from 10 to 100 μm.

Each of the layers C1 and C2, independently of each other, may comprise one or more additives, for example chosen from the group consisting of glidants, pigments, inks, fillers, heat stabilizers, UV stabilizers, antistatic agents, and mixtures thereof.

Preferably, each of the layers C1 and C2, independently of each other, comprises more than 80% by weight of polypropylene, more preferentially more than 90% by weight, and more preferentially still more than 99% by weight of a polypropylene (or of a mixture of polypropylenes), relative to the total weight of said layer C1 (or C2, respectively).

The two abovementioned layers C1 and C2 are preferably bonded together by the adhesive layer Ad.

Each of the layers C1 and C2, independently of each other, may include at least one layer chosen from aluminum oxides (AlOx), silicon oxides (SiOx), a metallization layer, and mixtures thereof.

The metallization layer is well known in the field, and corresponds to a very thin layer of aluminum, typically having a thickness of less than 100 nm, preferably ranging from 3 to 60 nm. The layer may be produced conventionally by vapor deposition on the surface of the substrate (of the layer C1 and/or C2).

The AlOx and SiOx layers are typically less than 500 nm, preferably less than 200 nm, for example of the order of 5 to 150 nm.

If they are present on the layers C1 and/or C2, these layers (AlOx, SiOx or metallization layer) may be in direct contact with the adhesive layer.

### Adhesive Layer Ad/Hot-Melt Adhesive Composition CA

The thickness of the adhesive layer Ad may be between 1 and 50 μm, preferably between 5 and 35 μm, and more preferentially still between 5 and 25 μm. The percentages by weight of the ingredients are relative to the total weight of said hot-melt pressure-sensitive adhesive composition CA.

In the context of the present invention, the term “copolymer” refers to a polymer obtained by the polymerization of at least two different monomers. The term “copolymer” includes terpolymers which comprise three different types of monomers.

Unless otherwise indicated, the standards mentioned throughout the patent application are those in force on the date of filing of the patent application.

### Copolymer A

The hot-melt pressure-sensitive adhesive composition CA preferably comprises from 45% to 80% by weight of copolymer(s) A, more preferentially still from 50% to 80% by weight, relative to the total weight of said composition. More preferably still, the composition CA comprises from 50% to 70% by weight of copolymer(s) A, relative to the total weight of said composition.

The copolymer A may have a lower density ranging from 0.800 to 0.899 g/cm³, preferably from 0.850 to 0.895 g/cm³, and more preferentially still from 0.860 to 0.880 g/cm³.

The density can be measured according to the standard ISO 1183-1.

The copolymer A may have a Shore A hardness of less than or equal to 90, preferably of less than or equal to 70, and more preferentially still of less than or equal to 65.

The Shore A hardness can be measured according to the standard ISO 868.

The copolymer A may have a polydispersity index (Mw/Mn) of less than or equal to 3, preferably ranging from 2 to 3.

The polydispersity index can be measured by size exclusion chromatography (SEC), for example using a standard of polystyrene type.

The copolymer A preferably comprises more than 82% by weight of units derived from but-1-ene, and more preferentially still more than 90% by weight of units derived from but-1-ene.

The copolymer A comprises units derived from an alpha-olefin, preferably chosen from ethylene, propylene, pentene, hexene, heptene, nonene, and mixtures thereof.

The copolymer A may comprise at most 20% by weight of units derived from alpha-olefin, preferably at most 18% by weight, and more preferentially still at most 10% by weight of units derived from alpha-olefin, and more preferentially from ethylene.

Preferably, the copolymer A is a but-1-ene-ethylene copolymer.

The percentages by weight of monomer units are relative to the total weight of said copolymer A.

The percentage by weight of monomer units can be determined by any known method, such as, for example, by NMR.

The copolymer A is preferably obtained by polymerization in the presence of catalysts of metallocene type which are well known in the field.

The copolymer A may also be commercially available. Mention may be made, for example, of the polymer Koattro KT MR06 sold by LyondellBasell, which is a C2/C4 copolymer having an MFI at 190° C., 2.16 kg, of 1.3 g/10 min and comprising a C2 ethylene content by mass of approximately 8.3%.

### Copolymer T

Preferably, the hot-melt pressure-sensitive adhesive composition CA comprises the copolymer T.

The hot-melt pressure-sensitive adhesive composition CA preferably comprises from 1.5% to 4.5% by weight of copolymer(s) T, preferentially from 1.8% to 4.3% by weight of copolymer(s) T, more preferentially from 2.0% to 4.0%, and more preferentially still from 2.0% to 3.5% by weight, relative to the total weight of said composition CA.

The copolymer T may be obtained by polymerization in the presence of a catalyst of metallocene or Ziegler-Natta type which are well known in the field.

A copolymer T may also be commercially available, such as Adsyl 7622 XCP sold by LyondellBasell comprising more than 50% by weight of units derived from propylene and having a melting point of 132° C. and also an MFI at 230° C., 2.16 kg, of 5.6 g/10 min.

The copolymer T preferably comprises more than 60% by weight of units derived from propylene, more preferentially more than 70% by weight of units derived from propylene, and more preferentially still more than 80% by weight of units derived from propylene.

Preferably, the copolymer T is a propylene-ethylene-butene copolymer T.

The copolymer T may comprise from 1% to 25% by weight of units derived from ethylene, preferably from 1% to 10% by weight of units derived from ethylene, and more preferentially still from 1% to 5% by weight of units derived from ethylene.

The copolymer T may comprise from 1% to 25% by weight of units derived from butene, preferably from 2% to 15% by weight of units derived from butene, and more preferentially still from 5% to 12% by weight of units derived from butene.

The percentages by weight of monomer units are relative to the total weight of said copolymer T.

The percentage by weight of monomer units can be determined by any known method, such as, for example, by NMR.

The copolymer T is preferably crystalline.

The copolymer T preferably has a melting point, measured by DSC (Differential Scanning calorimetry), ranging from 130° C. to 160° C.

The copolymer T preferably has a melt flow index (MFI) ranging from 0.6 to 10 g/10 min, preferably from 2 to 10 g/10 min, and more preferentially still from 4 to 8 g/10 min.

The melt flow index (MFI) of the copolymer T is measured at 230° C. and under a total weight of 2.16 kg, in accordance with condition d) of the standard ISO 1133. The MFI is the mass of composition (placed beforehand in a vertical cylinder) which flows in 10 minutes through a die with a fixed diameter, under the effect of a pressure exerted by a laden piston having the total weight of 2.16 kg.

Tackifying Resin iii)

The hot-melt pressure-sensitive adhesive composition CA comprises at least one nonhydrogenated tackifying resin iii) obtained by polymerization (or copolymerization with an aromatic hydrocarbon) of mixtures of unsaturated aliphatic hydrocarbons having from 4 to 6 carbon atoms (preferably around 5 carbon atoms) obtained from petroleum cuts.

When the tackifying resin is obtained by copolymerization of mixtures of unsaturated aliphatic hydrocarbons having from 4 to 6 carbon atoms with an aromatic hydrocarbon, this concerns in particular aromatic-modified aliphatic resins. It is well known to a person skilled in the art that the content of aliphatic radicals is greater than that of aromatic radicals in aromatic-modified aliphatic resins.

Preferably, the nonhydrogenated tackifying resin iii) is obtained by polymerization of mixtures of unsaturated aliphatic hydrocarbons having from 4 to 6 carbon atoms obtained from petroleum cuts.

The tackifying resin iii) may have a softening temperature (or point) ranging from 25° C. to 150° C., preferably from 30° C. to 130° C., more preferentially from 50° C. to 120° C., and more preferentially still from 90° C. to 120° C.

The softening temperature is determined in accordance with the standardized test ASTM E 28, the principle of which is as follows. A brass ring with a diameter of approximately 2 cm is filled with the resin to be tested in the molten state. After cooling to ambient temperature, the ring and the solid resin are placed horizontally in a thermostatically controlled bath of glycerol, the temperature of which can vary by 5° C. per minute. A steel ball with a diameter of approximately 9.5 mm is centered on the disk of solid resin. The softening temperature is the temperature, during the phase of rise in temperature of the bath at the rate of 5° C. per minute, at which the disk of resin yields by a height of 25.4 mm under the weight of the ball.

The tackifying resin iii) may have a weight-average molar mass Mw generally of between 300 and 5000 Da, preferably between 1000 and 2000 Da.

Mention may be made, among the tackifying resins iii), for example, of Escorez® 1310LC sold by ExxonMobil Chemical (softening temperature of 94° C. and an Mw of approximately 1800 Da) or also of Wingtack 98 sold by Cray Valley (softening temperature of 98° C. and an Mw of approximately 2000 Da).

The composition according to the invention may comprise a total content of tackifying resin(s) iii) ranging from 18.5% to 58.5% by weight, preferably from 18.5% to 53.5% by weight, preferentially from 18.5% to 48.5% by weight, and more preferentially still from 28.5% to 48.5% by weight, relative to the total weight of said composition.

The hot-melt pressure-sensitive adhesive composition CA may comprise a tackifying resin iii) as defined above or a mixture of tackifying resins iii) as defined above.

### Optional Tackifying Resin iv)

The hot-melt pressure-sensitive adhesive composition CA may also additionally comprise one or more tackifying resin(s) iv) different from the resin iii) as defined above.

The tackifying resin iv) may be chosen from those having a weight-average molar mass Mw of between 300 and 5000 Da.

The tackifying resin(s) iv) may be chosen in particular from:
iv-a) rosins of natural origin or modified rosins, such as, for example, the rosin extracted from pine gum, wood rosin extracted from tree roots and their derivatives which are hydrogenated, dehydrogenated, dimerized, polymerized or esterified with monoalcohols or polyols such as glycerol;
iv-b) resins obtained by hydrogenation, polymerization or copolymerization (with an aromatic hydrocarbon) of mixtures of unsaturated aliphatic hydrocarbons having approximately 9 or 10 carbon atoms obtained from petroleum cuts.

Mention may be made, among the tackifying resins (iv-a), for example, of Sylvalite® RE 100S from the company Kraton Polymers (ester of rosin and of pentaerythritol having a softening temperature of approximately 100° C.).

Mention may be made, among the tackifying resins (iv-b), for example, of Escorez® 5400 sold by the company ExxonMobil Chemical, which is a resin obtained by polymerization and then hydrogenation of a mixture of unsaturated aliphatic hydrocarbons having approximately 9 or 10 carbon atoms and which has a softening temperature of 100° C. and an Mw of approximately 570 Da.

Preferably, the hot-melt pressure-sensitive adhesive composition of the invention does not comprise a tackifying resin chosen from terpene resins.

Terpene resins cover in particular unmodified terpene resins, terpene resins modified by the action of phenols (terpene-phenol resins) and also terpene resins resulting from copolymerization (for example styrene/terpene). The terpene resins may result from the polymerization of terpene hydrocarbons, such as, for example, monoterpene (or pinene), in the presence in particular of Friedel-Crafts catalysts. Known in particular among the terpene resins are Dercolyte® S115 available from the company DRT (terpene resin having a softening temperature of 115° C. and an Mw of approximately 2300 Da) or also Sylvares® TR7115 from Kraton Polymers.

According to a preferred embodiment, the composition according to the invention does not comprise a tackifying resin other than the abovementioned tackifying resin(s) iii).

According to a preferred embodiment, the hot-melt pressure-sensitive adhesive composition CA does not comprise hydrogenated C9 aromatic resins.

### Additional/Optional Components

Preferably, the hot-melt pressure-sensitive adhesive composition CA comprises less than 0.1% by weight of styrene block copolymer (SBC), and more preferentially still less than 0.05% by weight, relative to the total weight of said composition. More advantageously still, the hot-melt pressure-sensitive adhesive composition does not comprise styrene block copolymer.

The styrene block copolymers consist of blocks of various polymerized monomers including at least one polystyrene block, and are typically prepared by radical polymerization techniques.

Preferably, the hot-melt pressure-sensitive adhesive composition CA comprises:
i) from 40% to 80% by weight of at least one but-1-ene-ethylene copolymer A, said copolymer comprising more than 80% by weight of units derived from but-1-ene;
ii) from 1.5% to 4.5% by weight of at least one propylene-ethylene-butene copolymer T, said copolymer T comprising more than 50% by weight of units derived from propylene;
iii) at least one nonhydrogenated tackifying resin obtained by polymerization, or copolymerization with an aromatic hydrocarbon, of mixtures of unsaturated aliphatic hydrocarbons having from 4 to 6 carbon atoms obtained from petroleum cuts.

According to one embodiment, the abovementioned hot-melt pressure-sensitive adhesive composition CA consists of:
i) from 45% to 80% by weight of at least one copolymer A as defined above;
ii) from 1.5% to 4.5% by weight of at least one copolymer T as defined above;
iii) at least one nonhydrogenated tackifying resin obtained by polymerization, or copolymerization with an aromatic hydrocarbon, of mixtures of unsaturated aliphatic hydrocarbons having from 4 to 6 carbon atoms obtained from petroleum cuts;
from 0% to 5% by weight of additional component chosen from the group consisting of stabilizers (antioxidants), plasticizers, anticaking agents, pigments, dyes, organic fillers, mineral fillers and mixtures thereof.

The total amount of additional component(s) may range from 0.01% to 2% by weight, preferably from 0.1% to 2% by weight, relative to the total weight of said composition.

The antioxidants may typically be introduced in order to protect the composition from degradation resulting from a reaction with oxygen which is liable to be formed by the action of heat, light or residual catalysts on certain starting materials, such as the tackifying resins.

These compounds may include primary antioxidants which trap free radicals and are generally substituted phenols, such as Irganox® 1010 from BASF. The primary antioxidants may be used alone or in combination with other antioxidants, such as phosphites, for instance Irgafos® 168, also from BASF, or also with UV stabilizers, such as amines.

The anticaking agents may be chosen from talc, calcium carbonate, calcium stearate, silica (natural or synthetic) or mixtures thereof.

Use may be made, as plasticizer, of a paraffinic and naphthenic oil (such as Primol® 352 from the company ExxonMobil) optionally comprising aromatic compounds (such as Nyflex 222B).

According to a preferred embodiment, the abovementioned hot-melt pressure-sensitive adhesive composition CA comprises:
i) from 45% to 80% by weight of at least one copolymer A as defined above;
ii) from 2.0% to 4.0% by weight of at least one copolymer T as defined above;
iii) at least one nonhydrogenated tackifying resin obtained by polymerization, or copolymerization with an aromatic hydrocarbon, of mixtures of unsaturated aliphatic hydrocarbons having from 4 to 6 carbon atoms obtained from petroleum cuts;
from 0% to 5% by weight of additional component chosen from the group consisting of stabilizers (antioxidants), plasticizers, anticaking agents, pigments, dyes, organic fillers, mineral fillers and mixtures thereof.

### Composition

The hot-melt pressure-sensitive adhesive composition CA may have a total content of polymers (copolymer A+copolymer T) ranging from 41.5% to 84.5%, preferably from 46.8% to 84.3%, more preferentially from 52% to 84%, and more preferentially still from 52% to 73.5%.

The hot-melt pressure-sensitive adhesive composition CA may comprise a polymers (copolymer A+copolymer T): tackifying resin(s) iii) mass ratio ranging from 40:60 to 90:10, preferably from 45:55 to 85:15, more preferentially still from 50:50 to 70:30.

The hot-melt pressure-sensitive adhesive composition CA according to the invention may have a melt flow index (MFI) ranging from 5 to 50 g/10 min, preferably from 5 to 20 g/10 min, and more preferentially still from 5 to 15 g/10 min.

The melt flow index (MFI) of the hot-melt pressure-sensitive adhesive composition CA is measured at 190° C. and under a total weight of 2.16 kg, in accordance with condition d) of the standard ISO 1133. The MFI is the mass of composition (placed beforehand in a vertical cylinder) which flows in 10 minutes through a die with a fixed diameter, under the effect of a pressure exerted by a laden piston having the total weight of 2.16 kg. Unless otherwise mentioned, the MFI values indicated in the present text were measured under these same conditions.

The hot-melt pressure-sensitive adhesive composition CA according to the invention is preferably provided in the form of granules of ellipsoidal shape, the mean dimensions of the major axis and of the minor axis of which are advantageously as follows:
mean dimension of the major axis of between 1 and 10 mm, preferably between 2 and 6 mm;
mean dimension of the minor axis of between 1 and 10 mm, preferably between 2 and 6 mm.

The mean dimensions are typically calculated by taking the mean over ten measurements.

The dimensions of the major axis and of the minor axis of the granules can be measured using a sliding caliper.

The hot-melt pressure-sensitive adhesive composition CA may be prepared in this form by a process which comprises:
a step of hot mixing the ingredients, between 150° C. and 220° C., by means of a twin-screw extruder equipped with a tool for cutting the extruded product of the underwater cutting type at the outlet of the die, then
a step of drying and cooling, for example to ambient temperature (23° C.).

The process may comprise a step of hot premixing the copolymers A and T as defined above, then said step of hot mixing the ingredients (of the premix with the other ingredients, such as, for example, the tackifying resin) between 150° C. and 250° C., by means of a twin-screw extruder equipped with a tool for cutting the extruded product of the underwater cutting type at the outlet of the die.

### Multilayer System F1

The multilayer system F1 may moreover comprise one or more additional layers (in addition to the abovementioned layers C1, Ad and C2).

These may be barrier layers (for example, layer based on proteins, layer based on aluminum oxides (AlOx), on silicon oxides (SiOx), on aluminum, on PVOH (polyvinyl alcohol), on copolymers of ethylene and of vinyl alcohol (EVOH), on copolymers of ethylene and of alkyl acrylate, on copolymers of ethylene and of vinyl acetate (EVA), etc.), tie layers (also called intermediate layers), printable layers, receptacle layers, etc.

The total thickness of the multilayer system F1 may be capable of varying within a wide range extending, for example, from 20 to 500 μm.

Preferably, the multilayer system F1 comprises at least 80%, preferentially at least 85% by weight, and more preferentially still at least 90% by weight, of polypropylene or of a mixture of polypropylenes, relative to the total weight of said system.

The multilayer system F1 may be obtained by any process known in the field.

The process may comprise a step of co-extruding the hot-melt pressure-sensitive adhesive composition CA and the constituent materials of the layers C1 and C2 and, where appropriate, additional layers.

The coextrusion device may be a bubble blowing coextrusion device (also known under the name of “blown film coextrusion device”). In a manner known to those skilled in the art, this process comprises:
the melting, in separate extruders, of the constituent materials and compositions of the layers Ad, C1 and C2; then
the passage of the corresponding streams through an assembly of annular and concentric dies, so as to form a tubular bubble comprising several layers, in the order corresponding to that desired for the final structure, then
the radial expansion (relative to the annular die) and drawing (in the axial direction) of the bubble; then
the cooling of the bubble.

The geometrical characteristics of the dies, as well as the parameters of the process, such as the degree of radial expansion and the drawing rate, are set so as to obtain the thicknesses desired for the various constituent layers of the multilayer film. For a more extensive description of the bubble blowing coextrusion process, reference is made in particular to the patent application US2013/0029553.

### Uses of the Adhesive Composition CA/Multilayer System F1

The present invention also relates to the use of the hot-melt pressure-sensitive adhesive composition CA comprising:
i) from 40% to 80% by weight of at least one copolymer A comprising more than 80% by weight of units derived from but-1-ene;
ii) optionally at least one copolymer T comprising more than 50% by weight of units derived from propylene;
iii) at least one nonhydrogenated tackifying resin obtained by polymerization, or copolymerization with an aromatic hydrocarbon, of mixtures of unsaturated aliphatic hydrocarbons having from 4 to 6 carbon atoms obtained from petroleum cuts; for preparing a recycled article.

The description and the preferred modes and embodiments described above for the hot-melt pressure-sensitive adhesive composition CA apply for the use without it being necessary to repeat them.

Preferably, the present invention relates to the use of the hot-melt pressure-sensitive adhesive composition CA comprising:
i) from 40% to 80% by weight of at least one but-1-ene-ethylene copolymer A, said copolymer comprising more than 80% by weight of units derived from but-1-ene;
ii) from 1.5% to 4.5% by weight of at least one propylene-ethylene-butene copolymer T, said copolymer T comprising more than 50% by weight of units derived from propylene;
iii) at least one nonhydrogenated tackifying resin obtained by polymerization, or copolymerization with an aromatic hydrocarbon, of mixtures of unsaturated aliphatic hydrocarbons having from 4 to 6 carbon atoms obtained from petroleum cuts;
for preparing a recycled article.

The present invention relates to the use of the hot-melt pressure-sensitive adhesive composition CA as defined above for preparing a recycled article comprising at least 2% by weight of a recycled multilayer system F1 comprising said adhesive composition CA, preferably at least 5% by weight, relative to the total weight of said recycled article.

The present invention also relates to the use of the multilayer system F1 as defined above, said system F1 preferably comprising:
a layer C1 comprising at least one polypropylene,
an adhesive layer Ad consisting of a hot-melt pressure-sensitive adhesive composition CA comprising:
   i) from 40% to 80% by weight of at least one but-1-ene-ethylene copolymer A, said copolymer comprising more than 80% by weight of units derived from but-1-ene;
   ii) from 1.5% to 4.5% by weight of at least one propylene-ethylene-butene copolymer T, said copolymer T comprising more than 50% by weight of units derived from propylene;
   iii) at least one nonhydrogenated tackifying resin obtained by polymerization, or copolymerization with an aromatic hydrocarbon, of mixtures of unsaturated aliphatic hydrocarbons having from 4 to 6 carbon atoms obtained from petroleum cuts;
a layer C2 comprising at least one polypropylene, said multilayer system F1 comprising at least 80% by weight of polypropylene or of a mixture of polypropylenes, relative to the total weight of said system;
for preparing a recycled article.

The description and the preferred modes and embodiments described above for the multilayer system F1 apply for the use without it being necessary to repeat them.

### Recycled Article

The recycled article may be a single-layer film, a laminate, a (multilayer) complex or a molded article, preferably a molded article.

The molded article may be a blow-molded article or an injection-molded article. The molded article is preferably an injection-molded article. Injection molding is well known. It is typically a process in which a thermoformable material is melted and injected at high pressure into a mold to form an article of a given size and shape.

In the context of the invention, the term “single-layer film” is understood to mean a film comprising a single layer, and thus differing from multilayer films.

The recycled article is preferably obtained by mechanical recycling of the multilayer system F1 according to the invention.

The recycled article preferably comprises less than 5% by weight of a copolymer A as described in the present patent application, relative to the total weight of said recycled article.

The content of copolymer A can be determined by gel permeation chromatography (GPC), for example using a trichlorobenzene (TCB) standard.

The recycled article preferably comprises at least 90%, more preferentially at least 95%, and more preferentially still at least 97% by weight, of polypropylene or of a mixture of polypropylenes, relative to the total weight of said recycled article.

The recycled article preferably comprises at least 2% by weight of the multilayer system F1 as defined in the present patent application, preferably at least 5% by weight, relative to the total weight of said recycled article.

The recycled article advantageously exhibits a breaking force of greater than or equal to 20 MPa, preferably of greater than or equal to 22 MPa, measured according to the standard ISO 527-1 (type 1A, test specimen dimensions 80×10×4 mm, pull rate 50 mm/min).

The recycled article advantageously exhibits an impact strength (Charpy method) of greater than or equal to 5.0, preferably of greater than or equal to 5.2, measured according to the standard ISO 179-2 1eA at 23° C. (test specimen dimensions 80×10×4 mm, rate of 2.9 m/s).

The recycled article advantageously exhibits an elongation at break of greater than or equal to 7 MPa, preferably of greater than or equal to 8 MPa, measured according to the standard ISO 527-1 (type 1A, test specimen dimensions 80×10×4 mm, pull rate 50 mm/min).

The present invention also relates to the use of the hot-melt pressure-sensitive adhesive composition CA according to the invention for improving the impact strength of a recycled article, preferably of a polypropylene-based recycled article.

More particularly, the use of the hot-melt pressure-sensitive adhesive composition CA of the invention advantageously makes it possible to improve, by at least 2%, preferably by at least 5%, and more preferentially still by at least 10%, the impact strength of a recycled article comprising said hot-melt pressure-sensitive adhesive composition, relative to a control article consisting of 100% polypropylene (preferably recycled polypropylene, more preferentially still having an MFR of approximately 8.95 g/10 min at 230° C./2.16 kg) and devoid of said hot-melt pressure-sensitive adhesive composition. It is obvious for the recycled article and the control article to have similar sizes and shapes for an appropriate comparison.

The impact strength is measured according to the abovementioned standard.

The recycled article is preferably prepared according to the process described below.

The present invention also relates to the use of the hot-melt pressure-sensitive adhesive composition CA according to the invention for improving the elongation at break of a recycled article, preferably of a polypropylene-based recycled article.

The elongation at break is measured according to the abovementioned standard.

More particularly, the use of the hot-melt pressure-sensitive adhesive composition CA of the invention advantageously makes it possible to increase, by at least 2%, preferably by at least 4%, and more preferentially still by at least 15%, the elongation at break of a recycled article comprising said hot-melt pressure-sensitive adhesive composition, relative to a control article consisting of 100% polypropylene (preferably recycled polypropylene, more preferentially still having an MFR of approximately 8.95 g/10 min at 230° C./2.16 kg) and devoid of said hot-melt pressure-sensitive adhesive composition. It is obvious for the recycled article and the control article to have similar sizes and shapes for an appropriate comparison.

The recycled article is preferably prepared according to the process described below.

### Process for Preparing a Recycled Article

The present invention also relates to a process for preparing a recycled article, said process comprising:
a) providing the multilayer system F1 as described in the present invention;
b) converting the multilayer system F1 into flakes;
c) optionally mixing the flakes obtained in step b) with recycled or virgin polypropylene;
d) converting the flakes from step b) or the mixture from step c) into a recycled article.

The description and the preferred modes and embodiments described above for the multilayer system F1 apply for the present process for preparing a recycled article, without it being necessary to repeat them.

Step b) is preferably a grinding step advantageously resulting in flakes. It may be carried out at 23° C.

The process may comprise an optional step b-1) of washing the flakes obtained in step b), and a drying step b-3).

The washing step b-1) may be carried out with water, optionally in the presence of additives, optionally with stirring.

The washing step b-1) advantageously makes it possible to remove residues present in the packagings, such as, for example, food waste or cosmetic residues from cosmetic packagings, or also to remove inks possibly present, or others.

The washing step b-1) may be carried out at a temperature ranging from 20° C. to 25° C.

The process may comprise a flotation step b-2) between step b-1) and step b-3). This step may be carried out by any means known to those skilled in the art.

The flakes resulting from the washing step iii-1) may be placed, during the washing step or after the washing step, in a tank with stirring. After the stirring has been stopped, the flotation/separation step advantageously makes it possible to separate the products that float from those (preferentially impurities) that are deposited at the bottom of the stirring tank. The flotation step is typically a density separation step. Polyolefins typically have a density of less than 1 g/cm³, which makes it possible to recover them generally at the surface.

The drying step b-3) may be carried out by any known method. It may be carried out at a temperature ranging from 50° C. to 100° C.

In the context of the invention, and unless mentioned otherwise, the term “virgin polypropylene” is understood to mean a newly produced polypropylene which has not been recycled.

The process may comprise a step b′) of densifying the flakes of step b), to form granules. The subsequent steps are then typically carried out on these granules.

Step c) may comprise mixing the flakes obtained in step b) with recycled or virgin polypropylene in a flakes: recycled (or virgin) PP ratio ranging from 1:99 to 99:1, preferably from 5:95 to 95:5, for example from 5:95 to 50:50.

The recycled or virgin polypropylene of step c) may be in the form of flakes or of granules, preferably in the form of flakes.

Step d) may be an extrusion, coextrusion or molding, for example injection molding, step.

Extrusion (coextrusion) advantageously makes it possible to prepare recycled films, while molding advantageously makes it possible to prepare molded articles.

Preferably, step d) is an injection molding step.

The process advantageously enables transformation of the multilayer system F1 into flakes or granules that can be reused to manufacture a new article.

### Recycled Article

The description, embodiments, and preferred modes disclosed above for the recycled article apply in the present process, without it being necessary to repeat them.

The present invention also relates to a recycled article capable of being obtained by the process for preparing a recycled article as defined above.

The present invention also relates to the use of the recycled article for the automotive field.

In the context of the invention, the term “between x and y” or “ranging from x to y” is understood to mean an interval in which the limits x and y are included. For example, the range “between 0% and 25%” in particular includes the values 0% and 25%.

The invention is now described in the following implementation examples, which are given purely by way of illustration and should not be interpreted as limiting the scope thereof.

### EXAMPLES

The following compounds were used in context of the examples:

Escorez® 1310 LC: Nonhydrogenated tackifying resin obtained by polymerization of a mixture of unsaturated aliphatic hydrocarbons having approximately 5 carbon atoms obtained from petroleum cuts. It exhibits a softening temperature of 94° C. (supplier ExxonMobil Chemical) Songnox® 1010 (supplier Songwon): Primary antioxidant Koattro KT MR06: C2/C4 copolymer having an MFI at 190° C., 2.16 kg, of 1.3 g/10 min and comprising a C2 ethylene content by mass of approximately 8.3% (supplier LyondellBasell)

Terpolymer T: C2/C3/C4 comprising approximately 3% by weight of C2, 9% by weight of C4, the remainder being C3, and having an MFI at 230° C. under 2.16 kg of 5.50 g/10 min

### Example 1: Preparation of a Hot-Melt Adhesive Composition

The adhesive composition (cf. table 1) is first prepared in the form of granules of ellipsoidal shape, the major axis and the minor axis of which respectively have a mean dimension of between 1 and 10 mm, preferably between 2 and 6 mm, by mixing the ingredients thereof at a temperature ranging from 150° C. to 200° C. by means of a twin-screw extruder, extruding through a die and then cutting up the product using a granulating tool of underwater cutting type, then drying and cooling to ambient temperature (23° C.). Table 1 shows percentages by weight.

TABLE 1

| | Composition 1 |
|---|---|
| C2/C3/C4 terpolymer | 4.2 |
| Koattro KT MR 06 | 55.5 |
| Regalite S1100 | — |
| Escorez ® 1310LC | 39.8 |
| Songnox ® 1010 SB (AO) | 0.5 |
| Total | 100 |
| MFI (g/10 min) | 11.0 |

### Example 2: Preparation of a Multilayer Film

A film is prepared, consisting:
of a first polypropylene film (RD204CF from Borealis) with a thickness of 30 μm;
of an adhesive layer between the two films, obtained from example 1 and of 14 μm;
of a second polypropylene film (RD204CF from Borealis) with a thickness of 15 μm.

This three-layer film is manufactured by means of a continuously operating bubble blowing coextrusion pilot-scale device, in which three extruders are fed:
for one, with the composition of example 1; and
for the other two, with polypropylene.

Several normal parameters were set, namely a degree of radial expansion of the bubble at 3.18, a drawing rate of 7 m/minute and an overall throughput of 11 kg/hour. The three-layer film thus obtained has a total thickness of 59 μm and a length of 50 m and is packaged in the form of a reel with a machine width of 250 mm.

The various materials were introduced into each extruder, in order to fill the screws and to form the polymer bubble at the outlet of the extrusion die. After purging for 30 minutes, the thicknesses and stability of the bubble controlled, 50 m of film were wound onto mandrels.

### Example 3: Process for Preparing Recycled Articles

### Step 1 of Grinding

The multilayer complex of example 2, PP/adhesive/PP, is ground using an MDS 340/150 shredder, 8 mm die, in order to obtain flakes. This grinding step results in a mixture of flakes.

### Step 2: Mixing with a Reference

Subsequently, the flakes from step 1 are mixed with recycled polypropylene granules (reference: PP sold by PreZero) in a ratio of 95:5 and 70:30 (reference: recycled multilayer film from step 1). The mixture is introduced into a Berstorff ZE 25, 36 L/D, twin-screw extrusion line, melted at a temperature greater than their melting temperatures, and then extruded. At the end of this step, granules are obtained.

The recycled polypropylene (reference) has an MFR of 8.95 g/10 min at 230° C. for a weight of 2.16 kg.

### Example 4: Mechanical and Thermal Properties of Molded Articles

### Breaking Force/Elongation at Break

The breaking force is measured according to the standard ISO 527-1 (type 1A) on injection-molded samples by a tensile test was carried out according to the protocol described below.

The principle of the measurement consists in drawing, in a tensile testing device, the movable jaw of which moves at a constant rate equal to 50 mm/minute, a standard test specimen consisting of the granules obtained in step 2 (or reference granules) and in recording, at the moment when the test specimen breaks, the tensile stress applied (in MPa) and also the elongation of the test specimen (in %). The standard test specimen is dumbbell-shaped, as illustrated in the international standard ISO 527. The narrow part of the dumbbell used has a length of 80 mm, a width of 10 mm and a thickness of 4 mm.

### Impact Strength (Charpy)

The impact strength is measured according to the DIN EN ISO 179-2 1eA method at 23° C. on ISO test specimens of type 1, with dimensions of 80×10×4 mm (rate of 2.9 m/s).

The mechanical properties of the various articles prepared are described in the following table:

| | Recycled | | | | | | | | |
|---|---|---|---|---|---|---|---|---|---|
| | granules of | Recycled | Polypropylene | | Delta | | | | |
| | example 3 - | polypropylene | granules | | relative to | | Delta | | Delta |
| | step 2 | granules | (RD204CF | Tensile | the control | Elongation | relative to | Impact | relative to |
| | (% by | (reference) | from Borealis) | strength | 4.1 | at break | the control | strength | the control |
| Example | weight) | (% by weight) | (% by weight) | (MPa) | (relative) | (%) | 4.1 | (Charpy) | 4.1 |
| 4.1 | 0% | 100% | — | 26.3 | n.a. | 7.79 | n.a. | 5.0 | n.a. |
| (control) | | | | | | | | | |
| 4.2 | 5% | 95% | — | 25.8 | 1.9% | 8.10 | 4% | 5.3 | 5% |
| (invention) | | | | | | | | | |
| 4.3 | 30% | 70% | — | 25.3 | 3.8% | 9.88 | 26.8% | 5.5 | 10% |
| (invention) | | | | | | | | | |
| 4.4 | 0% | 70% | 30% | n.d. | n.d. | 8.45 | n.d. | 4.8 | n.d. |
| (comparative) | | | | | | | | | |

n.d.: not determined
n.a.: not applicable

The articles 4.2 and 4.3 advantageously exhibit breaking forces virtually similar to that obtained for the reference article (control 4.1) which does not comprise recycled granules of example 3. The articles 4.2 and 4.3 advantageously exhibit a higher elongation at break than that of the reference article (control 4.1). It is higher still for the article 4.3.

The articles 4.2 and 4.3 advantageously exhibit a higher impact strength than that of the reference article (control 4.1). It is higher still for the article 4.3.

The article 4.3 (invention) differs from the article 4.4 in that it comprises within it the hot-melt pressure-sensitive adhesive composition resulting from the recycled film of example 2. The results of the table demonstrate that, advantageously, the presence of the pressure-sensitive adhesive composition does not negatively impact the thermal and mechanical properties. On the contrary, the elongation at break and the impact strength are advantageously improved compared to an article 4.4 devoid of adhesive composition.

The MFR is described in the following table:

| | Recycled | Recycled | |
|---|---|---|---|
| | granules of | polypropylene | |
| | example 3 - | granules | MFR (g/10 min) |
| | step 2 | (reference) | at 230° C. and |
| Example | (% by weight) | (% by weight) | 2.16 kg |
| 4.1 (control) | 0% | 100% | 8.95 |
| 4.2 (invention) | 5% | 95% | 8.41 |
| 4.3 (invention) | 30% | 70% | 7.94 |

The articles 4.2 and 4.3 advantageously exhibit an MFR close to the reference 4.1. This advantageously makes it possible to use injection molding conditions similar to the reference, without requiring additional adjustments.

1.-17. (canceled)

18. A multilayer system F1 comprising:
a layer C1 comprising at least one polypropylene,
an adhesive layer Ad consisting of a hot-melt pressure-sensitive adhesive composition CA comprising:
i. from 40% to 80% by weight of at least one copolymer A comprising more than 80% by weight of units derived from but-1-ene;
ii. optionally at least one copolymer T comprising more than 50% by weight of units derived from propylene; and
iii. at least one nonhydrogenated tackifying resin obtained by polymerization, or copolymerization with an aromatic hydrocarbon, of mixtures of unsaturated aliphatic hydrocarbons having from 4 to 6 carbon atoms obtained from petroleum cuts; and
a layer C2 comprising at least one polypropylene,
said multilayer system F1 comprising at least 80% by weight of polypropylene or of a mixture of polypropylenes, relative to the total weight of said system.

19. The multilayer system F1 as claimed in claim 18, characterized in that the hot-melt pressure-sensitive adhesive composition CA comprises from 45% to 80% by weight of copolymer(s) A, relative to the total weight of said composition.

20. The multilayer system F1 as claimed in claim 18, characterized in that the copolymer A comprises more than 82% by weight of units derived from but-1-ene.

21. The multilayer system F1 as claimed in claim 18, characterized in that the copolymer A is a but-1-ene-ethylene copolymer.

22. The multilayer system F1 as claimed in claim 18, characterized in that the hot-melt pressure-sensitive adhesive composition CA comprises from 1.5% to 4.5% by weight of copolymer(s) T, relative to the total weight of said composition CA.

23. The multilayer system F1 as claimed in claim 18, characterized in that the copolymer T is a propylene-ethylene-butene copolymer T.

24. The multilayer system F1 as claimed in claim 18, characterized in that the copolymer T comprises from 1% to 25% by weight of units derived from ethylene.

25. The multilayer system F1 as claimed in claim 18, characterized in that the total content of tackifying resin(s) iii) ranges from 18.5% to 58.5% by weight, relative to the total weight of said composition CA.

26. The multilayer system F1 as claimed in claim 18, characterized in that the hot-melt pressure-sensitive adhesive composition consists of:
i) from 40% to 80% by weight of at least one copolymer A;
ii) from 1.5% to 4.5% by weight of at least one copolymer T;
iii) at least one nonhydrogenated tackifying resin obtained by polymerization, or copolymerization with an aromatic hydrocarbon, of mixtures of unsaturated aliphatic hydrocarbons having from 4 to 6 carbon atoms obtained from petroleum cuts; and
iv) from 0% to 5% by weight of additional component chosen from the group consisting of stabilizers (antioxidants), plasticizers, anticaking agents, pigments, dyes, organic fillers, mineral fillers and mixtures thereof.

27. The multilayer system F1 as claimed in claim 18, characterized in that it comprises at least 80%, of polypropylene or of a mixture of polypropylenes, relative to the total weight of said system.

28. A recycle article comprising the multilayer system F1 as defined in claim 18.

29. The recycled article of claim 28, wherein the recycled article is a single-layer film, a laminate, a (multilayer) complex or a molded article.

30. The recycled article of claim 28 comprising at least 90%, of polypropylene or of a mixture of polypropylenes, relative to the total weight of said recycled article.

31. The recycled article of claim 28 having improved impact strength.

32. The recycled article of claim 28, wherein the impact strength of the recycled article comprising said hot-melt pressure-sensitive adhesive composition CA is at least 2%, improved, relative to a control article consisting of 100% polypropylene and devoid of said hot-melt pressure-sensitive adhesive composition.

33. A process for preparing a recycled article, said process comprising:
a) providing the multilayer system F1 as claimed in claim 18;
b) converting the multilayer system F1 into flakes;
c) optionally mixing the flakes obtained in step b) with recycled or virgin polypropylene;
d) converting the flakes from step b) or the mixture from step c) into a recycled article.
